(19) United States
(12) Patent Application Publication
(10) Pub. No.: US 2026/0088494 A1
(43) Pub. Date: Mar. 26, 2026

(54) BEAMFORMING ANTENNA CALIBRATION METHOD AND BEAMFORMING ANTENNA CALIBRATION SYSTEM

(71) Applicant: Industrial Technology Research Institute, Hsinchu (TW)

(72) Inventors: Po-Wei Chen, Hsinchu County (TW); Jeng-Jr Chang, Taoyuan City (TW); Tsan-Huang Chen, Taichung City (TW); Bor-Sen Chen, Hsinchu City (TW)

(73) Assignee: Industrial Technology Research Institute, Hsinchu (TW)

(21) Appl. No.: 18/894,004

(22) Filed: Sep. 24, 2024

(51) Int. Cl. H01Q 3/26; H01Q 3/36

(52) U.S. Cl. CPC H01Q 3/267; H01Q 3/36

(57) ABSTRACT

Disclosed is a beamforming antenna calibration method and a beamforming antenna calibration system. The method is adapted for a ground terminal device and includes the following steps. An original position information of a target satellite is obtained. A data pre-processing is performed on the original position information to obtain a processed position information of the target satellite. According to the processed position information of the target satellite, a deep neural network model is used to determine a control parameter for each of multiple antenna units in an antenna array. The antenna array is controlled to generate a target beam for communicating with the target satellite, according to the control parameter of each of the antenna units.

### TECHNICAL FIELD

The disclosure relates to a beamforming antenna calibration method and a beamforming antenna calibration system.

### BACKGROUND

Due to the low latency of low Earth orbit (LEO) satellites, and with the trend of decreasing costs and increasing demand for high-speed transmission, LEO satellite communication has become a major direction for future development. As LEO satellites move fast, the antenna of a ground terminal device must continuously adjust the beam direction in response to the changing position of the LEO satellite to ensure the establishment of a stable signal transmission channel. Only by doing so can the ground terminal device maintain high-quality communication with the LEO satellite.

Currently, various beam control methods for controlling antenna beam directions of ground terminal devices have been developed. For example, the antenna beam direction of a ground terminal device can be controlled through a lookup table method based on known satellite trajectories. However, the lookup table method is less accurate due to various uncertainties. Another method is controlling the antenna beam direction by beam scanning. However, this method requires a large antenna to perform large-scale scanning, and longer delays will occur during the scanning process. In addition, a signal decomposition method may be used to analyze the position of the LEO satellite according to received signals, thereby controlling the antenna beam direction of the ground terminal device. However, this method involves complex calculations and easily causes delays. It can be seen that these conventional technologies have respective shortcomings and struggle to meet the requirements for high accuracy and fast response at the same time.

### SUMMARY

The disclosure relates to a beamforming antenna calibration method and a beamforming antenna calibration system.

An embodiment of the disclosure relates to a beamforming antenna calibration method. The method is adapted to a ground terminal device and includes (but not limited to) the following steps. An original position information of a target satellite is obtained. A data pre-processing is performed on the original position information to obtain a processed position information of the target satellite. According to the processed position information of the target satellite, a deep neural network model is used to determine a control parameter of each of multiple antenna units in an antenna array. The antenna array is controlled to generate a target beam used to communicate with the target satellite according to the control parameter of each of the antenna units.

An embodiment of the disclosure relates to a beamforming antenna calibration system, including (but not limited to) a beamforming module and at least one processor. The beamforming module includes a transceiver and an antenna array. The processor is coupled to the beamforming module and configured to perform the following steps. An original position information of a target satellite is obtained. A data pre-processing is performed on the original position information to obtain a processed position information of the target satellite. According to the processed position information of the target satellite, a deep neural network model is used to determine a control parameter of each of multiple antenna units in an antenna array. The antenna array is controlled to generate a target beam used to communicate with the target satellite according to the control parameter of each of the antenna units.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a satellite communication system according to an exemplary embodiment of the disclosure.

FIG. 2 is a schematic diagram of a beamforming antenna calibration system according to an exemplary embodiment of the disclosure.

FIG. 3 is a schematic diagram of a beamforming module according to an exemplary embodiment of the disclosure.

FIG. 4 is a flowchart of a beamforming antenna calibration method according to an exemplary embodiment of the disclosure.

FIG. 5 is a schematic diagram of data pre-processing according to an exemplary embodiment of the disclosure.

FIG. 6 is a schematic diagram for determining control parameters of multiple antenna units according to an exemplary embodiment of the disclosure.

FIG. 7 is a schematic diagram for determining control parameters of multiple antenna units according to an exemplary embodiment of the disclosure.

FIG. 8 is a schematic diagram for performing phase offset compensation according to an attitude sensing information of a ground terminal device according to an exemplary embodiment of the disclosure.

FIG. 9 is a schematic diagram of a beamforming antenna calibration system according to an exemplary embodiment of the disclosure.

### DETAILED DESCRIPTION OF DISCLOSED EMBODIMENTS

The present disclosure can be understood by referring to the following detailed description of exemplary embodiments accompanied with drawings. It is to be understood that both the foregoing general description and the following detailed description are exemplary, and are intended to provide further explanation of the disclosure as claimed.

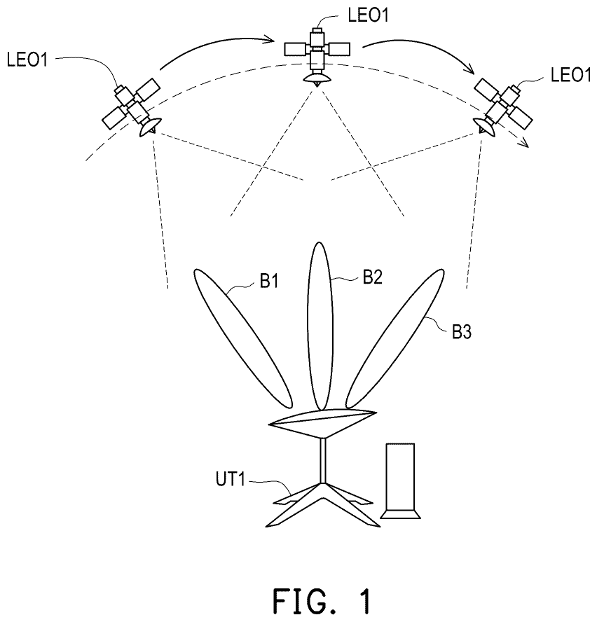

FIG. 1 is a schematic diagram of a satellite communication system according to an exemplary embodiment of the disclosure. Referring to FIG. 1, a satellite communication system 10 includes, but is not limited to, a ground terminal device UT1 and a target satellite LEO1.

In this embodiment, the ground terminal device UT1 is an equipment with wireless transceiver functions that may be deployed on land, including indoors or outdoors, and may be handheld, wearable, or vehicle-mounted. The ground terminal device UT1 may also be deployed on water, such as on a ship. The ground terminal device UT1 may further be deployed in the air, such as in an airplane or balloon. The ground terminal device UT1 may be a mobile phone with the function of communicating with a satellite base station, a pad, a computer with wireless transceiver functions, a virtual reality (VR) terminal device, an augmented reality (AR) terminal device, a wireless terminal for industrial control, a wireless terminal for self-driving, a wireless terminal for remote medical applications, a wireless terminal for smart grids, a wireless terminal for transportation safety, a wireless terminal for smart cities, a wireless terminal for smart homes, etc.

In this embodiment of the disclosure, the target satellite LEO1 is a low Earth orbit (LEO) satellite that orbits the Earth. As LEO satellites travel fast in low orbit paths, the ground terminal device UT1, which applies beamforming technology, continuously adjusts the beam direction in real time to maintain communication with the target satellite LEO1. In other words, as the target satellite LEO1 moves, the beam direction of the ground terminal device UT1 may need to be switched continuously. For example, as shown in FIG. 1, as the target satellite LEO1 moves, the communication beam of the ground terminal device UT1 is sequentially switched from a beam B1 to a beam B2, and then from the beam B2 to a beam B3.

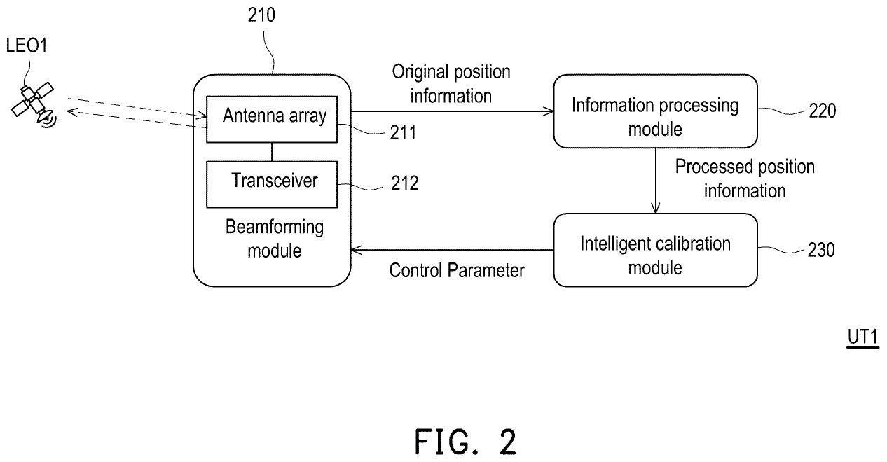

FIG. 2 is a schematic diagram of a beamforming antenna calibration system according to an exemplary embodiment of the disclosure. Referring to FIG. 2, in some embodiments of the disclosure, a beamforming antenna calibration system may include a beamforming module 210, an information processing module 220, and an intelligent calibration module 230. In some embodiments, the beamforming antenna calibration system may be implemented as the ground terminal device UT1 shown in FIG. 1.

In some embodiments, the beamforming module 210 may include an antenna array 211 and a transceiver 212. The transceiver 212 is coupled to the antenna array 211. The antenna array 211 may include multiple antenna units arranged in an array. In some embodiments, the antenna array 211 may be implemented as a patch array antenna. The antenna array 211 generates beams with different beam patterns. In some embodiments, a digital beam-former (DB) may be configured to control the signal phase and gain of each antenna unit in the antenna array to realize beam formation and adjustment.

In some embodiments, the information processing module 220 is used to perform data format conversion, data fusion, or other data pre-processing tasks. The information processing module 220 may perform data pre-processing on the original position information of the satellite LEO1 to generate the processed position information of the satellite LEO1.

In some embodiments, the original position information of the target satellite LEO1 includes real-time satellite information, predetermined satellite trajectory information, and attitude sensing information. For example, the original position information of the target satellite LEO1 may include two-line element set (TLE) data of the target satellite LEO1, Global Navigation Satellite System (GNSS) data of the target satellite LEO1, or satellite attitude data of the target satellite LEO1. The satellite attitude data of the target satellite LEO1 may be, for example, the angular velocity, attitude angles, and attitude quaternions of the target satellite LEO1.

In some embodiments, the processed position information of the target satellite LEO1 includes the satellite position information of the target satellite LEO1 that varies over time. For example, the processed position information of the target satellite LEO1 may include the longitude, latitude, or altitude of the target satellite LEO1. The processed position information of the target satellite LEO1 may include the relative position and relative angle of the target satellite LEO1 with respect to the ground terminal device UT1. The processed position information of the target satellite LEO1 may include the relative azimuth and relative elevation of the target satellite LEO1 with respect to the ground terminal device UT1, or the relative range between the target satellite LEO1 and the ground terminal device UT1.

In some embodiments, the information processing module 220 may be realized by one or more processors or controllers.

In some embodiments, the intelligent calibration module 230 determines the control parameter of each antenna unit in the antenna array 211 according to the processed position information of the target satellite LEO1 so as to adjust the beam formed by the ground terminal device UT1. It should be noted that the intelligent calibration module 230 utilizes a trained deep neural network (DNN) model to determine the control parameter of each antenna unit. The DNN model is an artificial neural network composed of multiple layers of neurons, which may include input layers, hidden layers, and output layers. Through the abstraction across multiple hidden layers, a DNN can learn and pick up complex patterns and features in statistics. The DNN model, with a multilayer structure and nonlinear activation functions, can handle highly complex and nonlinear problems. Descriptions of how to use the DNN model to determine the control parameter of each antenna unit will be provided in subsequent embodiments.

In other words, the intelligent calibration module 230 may utilize the trained DNN model to determine the control parameter of each antenna unit so that the antenna array 211 generates, according to the control parameters provided by the intelligent calibration module 230, a target beam suitable for communication with the target satellite LEO1. The control parameters provided by the intelligent calibration module 230 may include a gain control parameter and a phase control parameter used to control each antenna unit.

In some embodiments, under the circumstances when the intelligent calibration module 230 applies the DNN model, the intelligent calibration module 230 uses image acceleration hardware to operate the trained DNN model. The image acceleration hardware may include a graphics processing unit (GPU), a neural network processing unit (NPU), a convolutional neural network (CNN) accelerator, or an artificial intelligence (AI) accelerator. In other words, the intelligent calibration module 230 may be realized by processors or application-specific integrated circuits that accelerate the operation of the DNN model. This way, the convergence speed of beam calibration for the ground terminal device UT1 can be effectively improved.

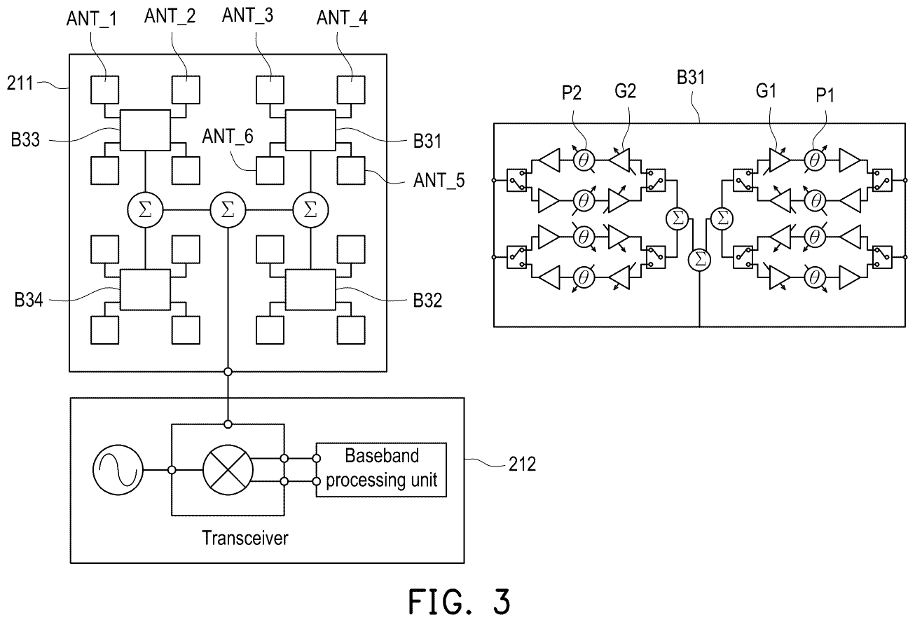

FIG. 3 is a schematic diagram of a beamforming module according to an exemplary embodiment of the disclosure. Referring to FIG. 3, the antenna array 211 of the beamforming module 210 may include multiple antenna units arranged in an array (such as antenna units ANT_1 to ANT_6). The antenna units are used to transmit and receive signals. In an example shown in FIG. 3, the antenna array 211 may include antenna units arranged in a 4×4 array, but is not limited thereto. The number and arrangement of antenna units in the antenna array 211 may be adjusted according to the specific application requirements.

In some embodiments, the transceiver 212 may include a local oscillator, a baseband processing unit, a mixer, etc. Specifically, the local oscillator provides a stable radio frequency signal, and the baseband processing unit handles signal modulation and demodulation. The mixer is used to convert a baseband signal to a radio frequency signal, or convert a received radio frequency signal back to a baseband signal. In some embodiments, the transceiver 212 may also include a filter and a low-noise amplifier to improve signal quality and system sensitivity.

In this example, the beamforming module 210 may further include multiple beamforming chips B31 to B34 connected to the antenna array 211. Each of the beamforming chips B31 to B34 is connected to four antenna units. For example, the beamforming chip B31 may be connected to the antenna units ANT_3 to ANT_6. Through the beamforming chips B31 to B34, the beamforming module 210 flexibly controls the signal transmission and reception of each antenna unit, thereby realizing complex beamforming and direction control functions.

In some embodiments, each of the beamforming chips B31 to B34 may include a phase shifter and a power amplifier corresponding to each antenna unit. Take the beamforming chip B31 for example. The beamforming chip B31 may include a phase shifter P2 and a power amplifier G2 connected to the antenna unit ANT_3. The beamforming chip B31 may also include a phase shifter P1 and a power amplifier G1 connected to the antenna unit ANT_4. Similarly, the other beamforming chips B32 to B34 also have corresponding phase shifters and power amplifiers so as to realize precise beam control. By adjusting the phase of the phase shifter and the gain of the power amplifier of each antenna unit, the antenna array 211 generates beams with specific beam patterns.

In this embodiment of the disclosure, the beamforming module 210 may control the phase of the phase shifter and the gain of the power amplifier of each antenna unit according to the control parameters provided by the intelligent calibration module 230 so as to generate the target beam used to communicate with the target satellite LEO1. The control parameters provided by the intelligent calibration module 230 include the phase control parameter and the gain control parameter for each antenna unit. The phase control parameter is used to control the phase of the phase shifter. The gain control parameter is used to control the gain of the power amplifier.

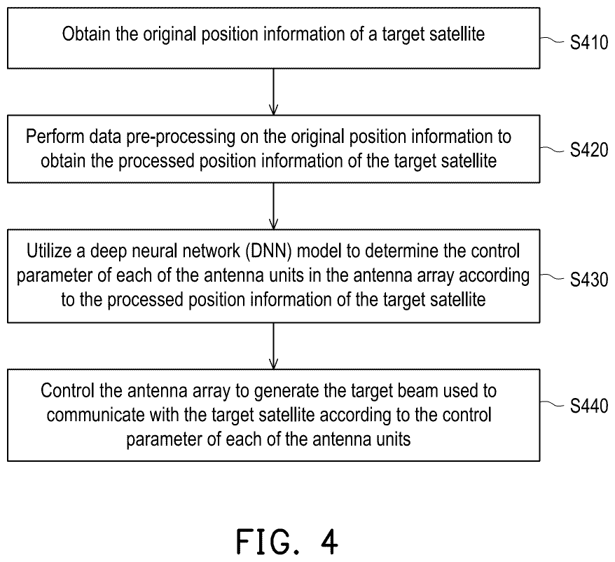

FIG. 4 is a flowchart of a beamforming antenna calibration method according to an exemplary embodiment of the disclosure. Referring to FIG. 4, in this embodiment of the disclosure, the beamforming antenna calibration method is adapted to the satellite communication system 10 and the ground terminal device UT1 as shown in FIGS. 1 and 2, and may include the following steps.

In Step S410, the ground terminal device UT1 obtains the original position information of the target satellite LEO1. In some embodiments, the ground terminal device UT1 may access specific websites or databases to obtain the original position information of the target satellite, such as the LTE data of the target satellite LEO1. In some embodiments, the ground terminal device UT1 may obtain the original position information of the target satellite according to a signal transmitted by the target satellite LEO1. For example, the ground terminal device UT1 may have a GNSS receiver to receive the transmitted signal of the target satellite LEO1, thereby obtaining the GNSS data or the GPS data of the target satellite LEO1. The GNSS data or the GPS data of the target satellite LEO1 may include the longitude, latitude, or altitude of the target satellite LEO1.

In Step S420, the ground terminal device UT1 performs data pre-processing on the original position information to obtain the processed position information of the target satellite LEO1. Data pre-processing may include data format conversion processing, data fusion processing, or other data pre-processing.

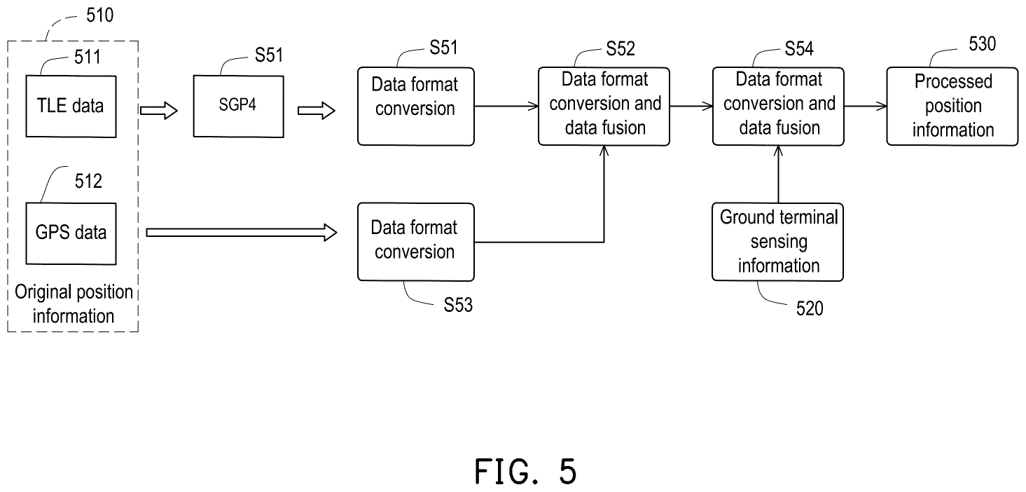

FIG. 5 is a schematic diagram of data pre-processing according to an exemplary embodiment of the disclosure. Referring to FIG. 5, in some embodiments, an original position information 510 of the target satellite LEO1 may include a TLE data 511 and a GPS data 512.

In Step S51, the ground terminal device UT1 utilizes a mathematical model to convert the TLE data 511 into Earth-centered inertial (ECI) coordinates of the target satellite LEO1. The mathematical model may be a SGP4 model (Simplified General Perturbations model 4), but is not limited thereto.

In Step S52, the ground terminal device UT1 performs data format conversion on the ECI coordinates of the target satellite LEO1 to generate Earth-centered Earth-fixed (ECEF) coordinates for the target satellite LEO1. On the other hand, in Step S53, the ground terminal device UT1 performs data format conversion on the latitude, longitude, and altitude in the GPS data 512 to generate the ECEF coordinates of the target satellite LEO1. In addition, in Step S52, the ground terminal device UT1 performs data fusion on the ECEF coordinates corresponding to the TLE data 511 and the ECEF coordinates corresponding to the GPS data 512. After data fusion, the fused ECEF coordinates are converted into the azimuth, elevation, and range of the spherical coordinate system of the target satellite LEO1. Alternatively, the ground terminal device UT1 may first respectively convert the ECEF coordinates corresponding to the TLE data 511 and the ECEF coordinates corresponding to the GPS data 512 into the azimuth, elevation, and range of the spherical coordinate system. Then, the ground terminal device UT1 performs data fusion on the azimuth, elevation, and range corresponding to the TLE data 511 and the azimuth, elevation, and range corresponding to the GPS data 512 so as to generate the azimuth, elevation, and range of the spherical coordinate system for the target satellite LEO1.

In Step S54, the ground terminal device UT1 obtains a ground terminal sensing information 520 of the ground terminal device UT1. The ground terminal sensing information 520 may include attitude sensing information or position information. The ground terminal device UT1 may perform data format conversion on the ground terminal sensing information 520 to obtain the azimuth, elevation, and range of the spherical coordinate system of the ground terminal sensing information 520. Then, the ground terminal device UT1 performs data fusion on the azimuth, elevation, and range of the spherical coordinate system of the ground terminal sensing information 520 and the azimuth, elevation, and range of the spherical coordinate system of the target satellite LEO1 so as to obtain a processed position information 530 of the target satellite LEO1. In some embodiments, the processed position information 530 may include the relative position information of the target satellite LEO1 with respect to the ground terminal device UT1, i.e., the relative azimuth, relative elevation angle, and relative range of the target satellite LEO1 with respect to the ground terminal device UT1.

Returning to FIG. 4, in Step S430, the ground terminal device UT1 utilizes the DNN model to determine the control parameter of each of the antenna units in the antenna array 211 according to the processed position information of the target satellite LEO1. In some embodiments, the control parameter of each of the antenna units includes a phase control parameter and a gain control parameter. In other words, the ground terminal device UT1 may determine the signal phase and the signal gain corresponding to each antenna unit by inputting the satellite orbit information of the target satellite LEO1 into the DNN model.

In Step S440, the ground terminal device UT1 controls the antenna array 211 to generate the target beam used to communicate with the target satellite LEO1 according to the control parameter of each of the antenna units. Referring to FIG. 2, it is known that the intelligent calibration module 230 of the ground terminal device UT1 provides the control parameter of each antenna unit to the beamforming module 210. Thus, the beamforming module 210 can control the signal phase and the signal amplitude of each antenna unit according to the control parameters determined by the intelligent calibration module 230, thereby generating the target beam used to communicate with the target satellite LEO1.

In some embodiments, by simulating each of the antenna units as an image pixel, the ground terminal device UT1 may operate the DNN model using an image acceleration hardware, thereby determining the control parameter of each of the antenna units in the antenna array 211. In other words, each antenna unit in the antenna array 211 can be simulated as a pixel in image processing. The DNN model used for image processing may output the control parameter corresponding to each pixel according the data input into the model (i.e., the processed position information). In some embodiments, the image acceleration hardware accelerates perturbation parameters to feedback to and update the control parameters.

In some embodiments, the processed position information of the target satellite LEO1 may be input into the DNN model so that the DNN model outputs accurate satellite status information. The satellite status information may include satellite trajectory information and satellite attitude information. The satellite status information output by the DNN model may be translated into the control parameter of each antenna unit.

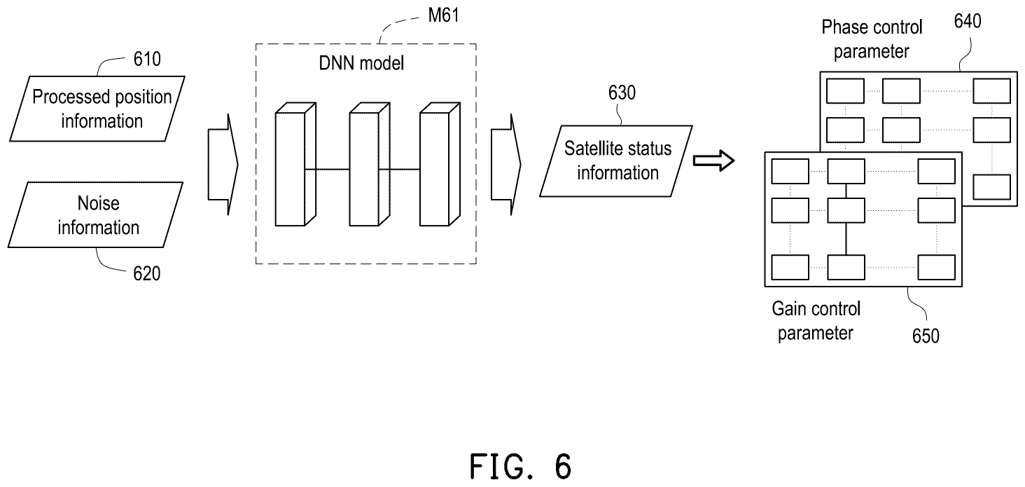

In detail, FIG. 6 is a schematic diagram for determining control parameters of multiple antenna units according to an exemplary embodiment of the disclosure. Referring to FIG. 6, in some embodiments, a DNN model M61 is trained by solving the nonlinear state equation of the target satellite LEO1 using the DNN model M61. In addition, the establishment of the nonlinear state equation describing the trajectory and attitude of the target satellite LEO1 takes into account various environmental noise and communication noise. Thus, when the trained DNN model M61 is used online, the ground terminal device UT1 inputs the processed position information 610 of the target satellite LEO1 and a current noise information 620 into the DNN model M61 so that the DNN model outputs an accurate satellite status information 630. Then, the ground terminal device UT1 generates the control parameter of each of the antenna units according to the satellite status information 630.

More specifically, the trained DNN model M61 may be used for online inference and outputting accurate trajectory and attitude information according to the current processed position information 610 and current interference noise. In some embodiments, the satellite status information 630 may include corrected satellite trajectory information or corrected satellite attitude information. In some embodiments, the satellite status information 630 may include satellite status error compensation. Then, the ground terminal device UT1 determines a phase control parameter 640 and a gain control parameter 650 of each antenna unit according to the satellite status information 630 output by the DNN model M61. In other words, the ground terminal device UT1 determines the target beam direction according to the accurate trajectory and attitude information, and determines the phase control parameter 640 and the gain control parameter 650 of each antenna unit according to the target beam direction.

On the other hand, when training the DNN model M61 to output accurate satellite status information, the nonlinear state equation of the target satellite LEO1 may be established first. The nonlinear state equation is used to describe the trajectory and attitude of the target satellite LEO1. It should be noted that, in some embodiments, when establishing the nonlinear state equation of the target satellite LEO1, various ambient interference noises and communication noises may be taken into consideration. These interference noises may include atmospheric disturbances, solar wind, geomagnetic field effects, interference noise caused by the instability of the wireless transmission network, etc.

After determining the nonlinear state equation, the model may be trained by generating a large amount of simulated training data or virtual training data. In other words, the training of the DNN model M61 does not rely on actual data. Instead, the DNN model M61 is trained based on simulated training data or virtual training data. The simulated training data or virtual training data may cover the behaviour of the target satellite LEO1 under various trajectories and attitudes as well as noise effects within a certain range. Based on this, by utilizing the large amount of simulated training data or virtual training data, the DNN model M61 learns to accurately predict the trajectory and attitude of the target satellite under different conditions during the training process. In addition, to enhance the robustness of the DNN model M61 during the training process, anti-interference control strategies may be introduced. For example, random noise or disturbances may be added to the training data so that the DNN model M61 learns to maintain prediction accuracy within an error range. This way, the ground terminal device UT1 may utilize the data output by the DNN model M61 to determine the phase control parameter 640 and the gain control parameter 650 more accurately.

In some other embodiments, the processed position information of the target satellite LEO1 may be input into the DNN model so that the DNN model outputs the control parameter of each antenna unit. Further, the ground terminal device UT1 may input the processed position information of the target satellite LEO1 into the DNN model so that the DNN model outputs a control parameter matrix. The control parameter matrix includes the control parameter of each of the antenna units.

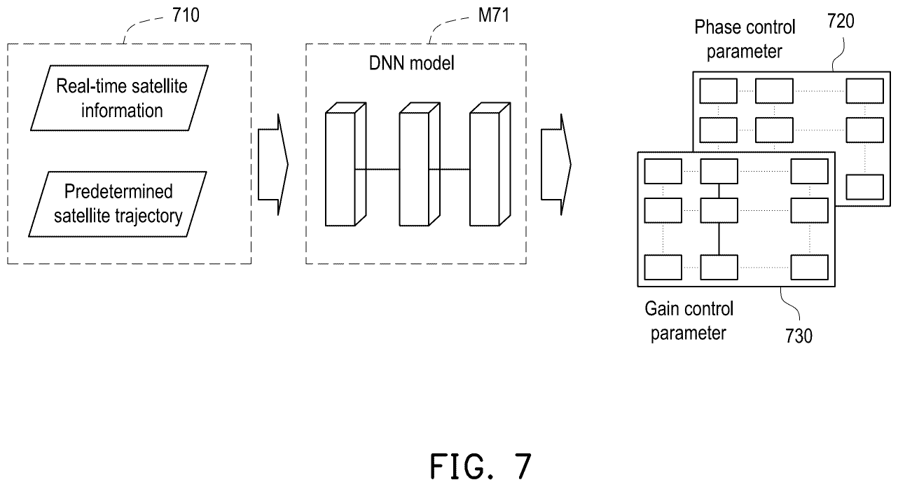

In detail, FIG. 7 is a schematic diagram for determining control parameters of multiple antenna units according to an exemplary embodiment of the disclosure. Referring to FIG. 7, a processed position information 710 of the target satellite LEO1 includes real-time satellite information and predetermined satellite trajectory information. The ground terminal device UT1 may input the processed position information 710 into a DNN model M71. The DNN model M71 may output a gain control parameter 730 of each antenna unit and a phase control parameter 720 of each antenna unit. In other words, the DNN model M71 may output a first control parameter matrix, and the first control parameter matrix includes the gain control parameter 730 of each antenna unit. The DNN model M71 may also output a second control parameter matrix, and the second control parameter matrix includes the phase control parameter 720 of each antenna unit. More specifically, the trained DNN model M71 may be used for online inference and outputting the control parameter of each antenna unit according to the current processed position information 710.

On the other hand, in some embodiments, the DNN model M71 is trained using training data that includes noise interference. Specifically, when training the DNN model M71 to output accurate satellite status information, satellite trajectory information with noise interference may be actually collected, or noise interference may be added to the satellite trajectory information to obtain the model training data. In addition, the phase control parameters and the gain control parameters in the model training data may be obtained through tests, signal decomposition algorithms, or beam scanning procedures.

In this embodiment of the disclosure, as the DNN model is trained with interference noise taken into consideration, the DNN model has high practicality and robustness. In addition, by using an AI accelerator to operate the trained DNN model, the advantages of low latency and fast response can be achieved while ensuring the accuracy of beam calibration.

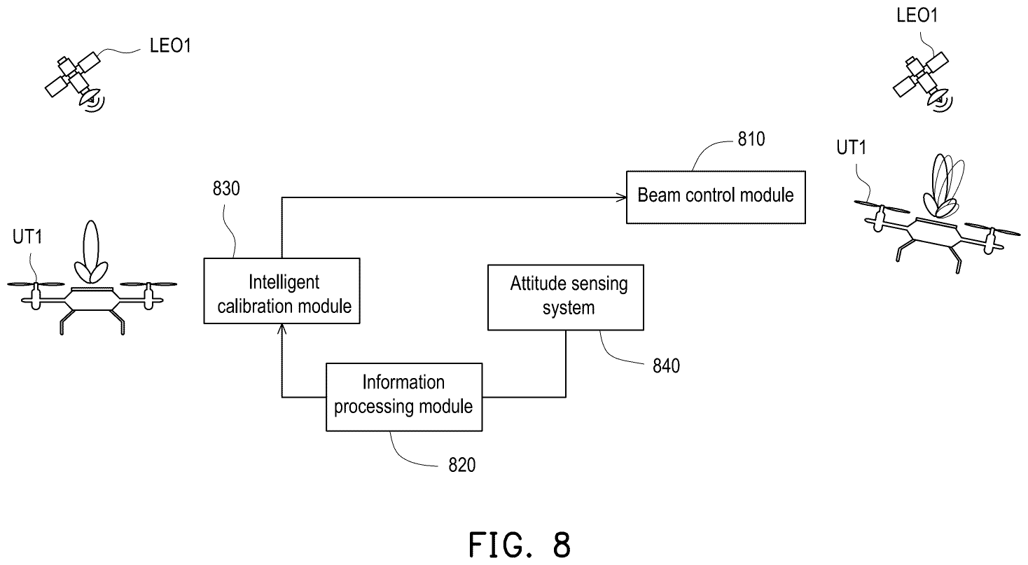

FIG. 8 is a schematic diagram for performing phase offset compensation according to an attitude sensing information of a ground terminal device according to an exemplary embodiment of the disclosure. In some embodiments, the ground terminal device UT1 may detect the attitude sensing information of the ground terminal device UT1. The ground terminal device UT1 may obtain the processed position information of the target satellite LEO1 according to the attitude sensing information of the ground terminal device. For example, in an example shown in FIG. 8, the ground terminal device UT1 may be an aircraft (e.g., a drone). During the flight of the ground terminal device UT1, the position and attitude of the ground terminal device UT1 continuously change. An attitude sensing system 840 of the ground terminal device UT1 detects the attitude sensing information of the ground terminal device UT1. The attitude sensing system 840 may include a multi-axis inertial sensor. The attitude sensing information of the ground terminal device UT1 may include an attitude angle, e.g., a yaw angle, a roll angle, a pitch angle, or an attitude quaternion. An information processing module 820 of the ground terminal device UT1 filters out outliers for abnormal attitude angles according to measured values from a magnetometer and a temperature sensor. In some embodiments, the information processing module 820 of the ground terminal device UT1 may convert the attitude quaternion into an Euler angle coordinate. The information processing module 820 of the ground terminal device UT1 may calculate the relative position information of the target satellite LEO1 with respect to the ground terminal device UT1 according to the attitude angle (the attitude sensing information) of the ground terminal device UT1, thereby obtaining the processed position information of the target satellite LEO1.

Next, an intelligent calibration module 830 of the ground terminal device UT1 may determine the control parameter of each antenna unit according to the relative position information of the target satellite LEO1 with respect to the ground terminal device UT1. Thus, a beam control module 810 forms a target beam aligned with the target satellite LEO1 according to the control parameters provided by the intelligent calibration module 830.

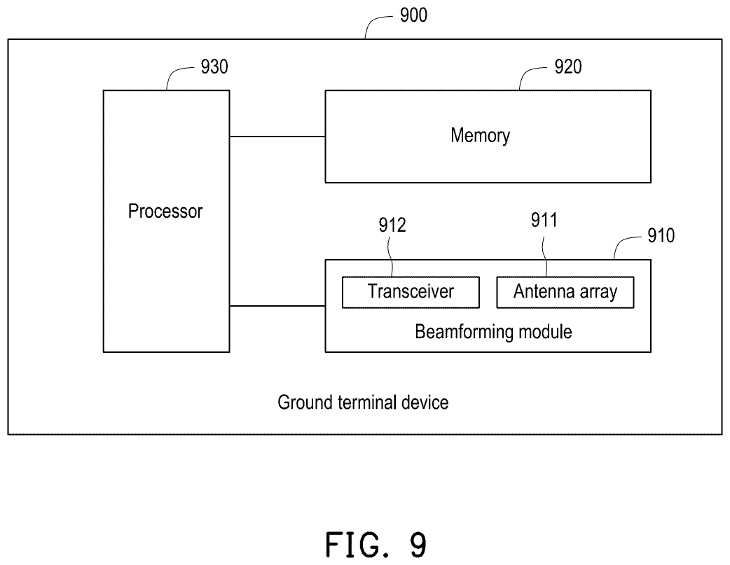

FIG. 9 is a block diagram of a wireless communication device according to an embodiment of the disclosure. Referring to FIG. 9, a ground terminal device 900 may include, but is not limited to, a processor 930, a memory 920, and a beamforming module 910. The beamforming antenna calibration system of the disclosure may be realized as the ground terminal device 900.

The processor 930 is, for example, a central processing unit (CPU), another programmable general-purpose or specific-purpose microprocessor, a digital signal processor (DSP), a programmable controller, an application specific integrated circuit (ASIC), a graphics processing unit (GPU), another similar element, or a combination of the above elements. The processor 930 is configured to execute the beamforming antenna calibration method.

The memory 920 is coupled to the processor 930 and may be, for example, any type of fixed or removable volatile or non-volatile memory, such as random access memory (RAM), read-only memory (ROM), flash memory, hard disk drives (HDD), solid state drives (SSD), other similar elements, or a combination of the above elements. The memory 920 stores multiple modules or programs to be accessed by the processor 930.

The beamforming module 910 is coupled to the processor 930. The beamforming module 910 includes a transceiver 912 and an antenna array 911. The transceiver 912 receives downlink (DL) signals and transmit uplink (UL) signals. The transceiver 912 may perform operations such as low noise amplification (LNA), impedance matching, analog-to-digital conversion (ADC), digital-to-analog conversion (DAC), frequency mixing, up-down frequency conversion, filtering, amplification, and/or similar operations. The antenna array 911 may include multiple antenna units arranged in an array.

In summary, in the embodiments of the disclosure, by using the DNN model to automatically control the phase control parameters and the gain control parameters of the antenna units according to the status information of the target satellite, not only can the beam alignment of the ground terminal device be more accurate, the advantages of fast response and low latency can also be provided. In addition, the size of the antenna array is not limited, allowing for a wide range of applications.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A beamforming antenna calibration method, adapted to a ground terminal device, comprising:
obtaining an original position information of a target satellite;
performing a data pre-processing on the original position information to obtain a processed position information of the target satellite;
according to the processed position information of the target satellite, using a deep neural network model to determine a control parameter of each of a plurality of antenna units in an antenna array; and
controlling the antenna array to generate a target beam used to communicate with the target satellite according to the control parameter of each of the plurality of antenna units.

2. The method according to claim 1, wherein the original position information of the target satellite comprises a real-time satellite information, a predetermined satellite trajectory information, and an attitude sensing information, and the processed position information of the target satellite comprises a satellite position information of the target satellite, the satellite position information varying over time.

3. The method according to claim 1, wherein the control parameter of each of the plurality of antenna units comprises a phase control parameter and a gain control parameter.

4. The method according to claim 1, wherein according to the processed position information of the target satellite, using the deep neural network model to determine the control parameter of each of the plurality of antenna units in the antenna array comprises:
by simulating each of the plurality of antenna units as an image pixel, operating the deep neural network model through an image acceleration hardware to determine the control parameter of each of the plurality of antenna units in the antenna array.

5. The method according to claim 4, wherein the image acceleration hardware comprises a graphics processing unit, a neural network processing unit, a convolutional neural network accelerator, or an artificial intelligence accelerator.

6. The method according to claim 1, wherein according to the processed position information of the target satellite, using the deep neural network model to determine the control parameter of each of the plurality of antenna units in the antenna array comprises:
inputting the processed position information into the deep neural network model such that the deep neural network model outputs a control parameter matrix, wherein the control parameter matrix comprises the control parameter of each of the plurality of antenna units.

7. The method according to claim 1, wherein according to the processed position information of the target satellite, using the deep neural network model to determine the control parameter of each of the plurality of antenna units in the antenna array comprises:
inputting the processed position information and a noise information into the deep neural network model such that the deep neural network model outputs a satellite status information; and
generating the control parameter of each of the plurality of antenna units according to the satellite status information.

8. The method according to claim 7, wherein the deep neural network model is trained by solving a nonlinear state equation of the target satellite through the deep neural network model.

9. The method according to claim 1, wherein the deep neural network model is trained using a training data that comprises a noise interference.

10. The method according to claim 1, wherein performing the data pre-processing on the original position information to obtain the processed position information of the target satellite comprises:
detecting an attitude sensing information of the ground terminal device; and
obtaining the processed position information of the target satellite according to the attitude sensing information of the ground terminal device.

11. A beamforming antenna calibration system, comprising:
a beamforming module, comprising a transceiver and an antenna array; and
at least one processor, coupled to the beamforming module and configured to:
obtain an original position information of a target satellite;
perform a data pre-processing on the original position information to obtain a processed position information of the target satellite;
according to the processed position information of the target satellite, use a deep neural network model to determine a control parameter of each of a plurality of antenna units in the antenna array; and
control the antenna array to generate a target beam used to communicate with the target satellite according to the control parameter of each of the plurality of antenna units.

12. The beamforming antenna calibration system according to claim 11, wherein the original position information of the target satellite comprises a real-time satellite information, a predetermined satellite trajectory information, and an attitude sensing information, and the processed position information of the target satellite comprises a satellite position information of the target satellite, the satellite position information varying over time.

13. The beamforming antenna calibration system according to claim 11, wherein the control parameter of each of the plurality of antenna units comprises a phase control parameter and a gain control parameter.

14. The beamforming antenna calibration system according to claim 11, wherein the at least one processor is configured to:
by simulating each of the plurality of antenna units as an image pixel, operate the deep neural network model through an image acceleration hardware to determine the control parameter of each of the plurality of antenna units in the antenna array.

15. The beamforming antenna calibration system according to claim 14, wherein the image acceleration hardware comprises a graphics processing unit, a neural network processing unit, a convolutional neural network accelerator, or an artificial intelligence accelerator.

16. The beamforming antenna calibration system according to claim 11, wherein the at least one processor is configured to:
input the processed position information into the deep neural network model such that the deep neural network model outputs a control parameter matrix, wherein the control parameter matrix comprises the control parameter of each of the plurality of antenna units.

17. The beamforming antenna calibration system according to claim 11, wherein the at least one processor is configured to:
inputting the processed position information and a noise information into the deep neural network model such that the deep neural network model outputs a satellite status information; and
generating the control parameter of each of the plurality of antenna units according to the satellite status information.

18. The beamforming antenna calibration system according to claim 17, wherein the deep neural network model is trained by solving a nonlinear state equation of the target satellite through the deep neural network model.

19. The beamforming antenna calibration system according to claim 11, wherein the deep neural network model is trained using a training data that comprises a noise interference.

20. The beamforming antenna calibration system according to claim 11, wherein the at least one processor is configured to:
detect an attitude sensing information of a ground terminal device; and
obtain the processed position information of the target satellite according to the attitude sensing information of the ground terminal device.
